(19) United States
(12) Patent Application Publication
(10) Pub. No.: US 2010/0018088 A1
(43) Pub. Date: Jan. 28, 2010

(54) Audio and or video electronic scrolling display on various kinds of bags to display owner contact information

(76) Inventor: Vinod Rajpal, Washington, DC (US)

Correspondence Address: VINOD RAJPAL, 2524 QUEEN ANNES LN. NW, WASHINGTON, DC, 20037, US

(21) Appl. No.: 12/115,389

(22) Filed: Jul. 22, 2008

(51) Int. Cl. G09F 27/00

(52) U.S. Cl. 40/5

(57) ABSTRACT

An audio/visual electronic scrolling display permanently embedded in baggage used by travelers and on commercial containers used in the shipping of cargo in commerce. The audio and visual display system is based on chip technology, resists static electricity generated by huge luggage conveyors and baggage scanning systems found at airports. It is lightweight, weather proof and readable in a choice of different languages. The baggage and containers are easily trackable via the LED light-emitting display panel and the sound system. The visual messages can be manually programmed via a keyboard or electronically programmed using the USB computer outlet. A computer chip activates both the visual characters and sound. Electric power is supplied by a 9 volt rechargeable battery. There are brightness and sound control buttons. Activation is effected by an outside on/off pressure switch. U.S. Current Class: 385

This is a combination audio/video electronic LED scrolling display panel which provides audio and video electronic information such as owner identification, shipping destination, contents and shipping instructions for air and rail travel including standard commercial shipping of containers in worldwide commerce, air, land, or sea (FIG. 1 and FIG. 2). The purpose of the invention is to provide electronic video and audio information to reduce the problems associated with the loss, delay, or misplacement of luggage and containers during travel or shipment. Additionally, the sound aspect of this electronic information device (FIG. 7, speaker, and FIG. 8, recorder) will assist blind passengers in locating and retrieving their luggage at the airport. Sound messages are created using the speaker and audio recording system embedded in luggage or on the outside of the cargo shipping container.

The device can be used on luggage of all kinds including brief cases, golf bags, a computer lap top case, and any other baggage an airline or train passenger would use while traveling. It also can be affixed to a cargo container currently being used for shipments by the shipping industry worldwide. The device displays video lighted messages on an LED screen. Such information would include identification and contact information of the owner including travel itinerary and ultimate destination. It can be set for a single or as many as seven languages. It incorporates a scrolling system as a display panel in black and white or color characters (numbers and letters) to create illuminated messages. The device is powered by a 9 volt rechargeable lithium battery (FIG. 3). An on-off pressure button operated from the outside of the bag (FIG. 6) activates the device. A brightness control (FIG. 9) adjusts the brilliancy of the message and the volume control (FIG. 11) controls the sound.

It employs electronic technology both in the audio and visual modes. The technology employed for both visual and audio presentation utilizes a computer memory chip (FIG. 10) which stores both video and audio information for transmission to the scrolling display panel. The messages are set electronically through the computer keyboard (FIG. 4), stored in the memory chip (FIG. 10) and then transmitted to the LED display panel.

The information for the LED screen from a chip is conveyed via a computer which then transfers the visual message and sound to the display panel (FIG. 3) and speaker (FIG. 7). The visual function can also be set manually using the keyboard (FIG. 4).

### BACKGROUND OF THE INVENTION

The subject matter of the invention relates to an electronic device in the form of a permanent LED display panel (FIG. 3) which is both manually programmed through a computer keyboard (FIG. 4) located inside the bag or on a container (FIG. 1 and FIG. 2) or electronically programmed to display visual and audio data such as the contents of the baggage or shipping container including the itinerary of the owner and/or the destination of the baggage or shipped cargo. The electronic system is powered by a 9 volt lithium rechargeable battery (FIG. 5) embedded in the device. The information and data can be displayed on the display panel (FIG. 3) in up to seven (7) languages. The computer chip (FIG. 10) stores up to 7 full messages with each message having up to 255 characters. The message is created by sound and visually using the numbers 1-9 and alphabet characters A to Z. The messages can be programmed in advance. The visual display in the display panel (FIG. 3) can be presented randomly, flash, open, left, right, up or down, or constant to display modes for effects. It is able to show either selected messages or all the messages in series with 8 speed options. There is a display brightness adjustment control (FIG. 9) and an on/off power pressure touch button on the outside (FIG. 6).

The invention identifies the long term problem the airlines encounter in assuring that its passengers receive their baggage promptly without unnecessary delay. The invention will help to immediately identify and locate baggage and help to avoid lost, misdirected, or misplaced baggage and shipments. It will be exceptionally valuable to blind travelers when the sound display is activated. The speaker and the sound mechanism have the capacity to transmit audible sound to a person with normal hearing at a distance of 15 to 20 feet from the carousel where the passengers retrieve their baggage. In the shipping industry the device will be helpful in determining the nature of contents of the cargo including special handling requirements and specific directions for timely delivery especially in the case of produce or other perishable goods. The prior art for both the airlines and the cargo shipping industry has been printed labels temporarily attached to the baggage or containers which are difficult to read for the average employee and are easily lost or damaged in the shipping process; subject invention will provide a new use to an old prior art.

### BRIEF SUMMARY OF THE INVENTION

It is the object of the present invention to combine dual audio-video display functions capable of displaying visual and sound messages when mounted on traveling bags or cargo containers used in commerce. The dual audio-video display system is able to provide to viewers messages, both visual and sound, identifying the owners of the traveling baggage or shipping container including the itinerary and destination. It can be programmed both electronically and manually via a keyboard mounted inside the baggage or outside the cargo container in up to seven (7) different languages. Electric programming is accomplished via the computer chip (FIG. 10).

To achieve the above object, a light-emitting readable panel displays the video on an LED screen providing identification and contact information. The panel can also display the contents of the baggage or the container which is important for security reasons and handling of the baggage or cargo in the container. This same feature can be accomplished with the embedded sound system which includes a speaker or transmitter which provides information to the viewer. The sound aspect is especially valuable and helpful to the blind traveler who would be unable to read the visual display. The sound is transmitted via a preprogrammed speaker activated by the computer memory chip which contains both the video and audio sound.

The advantages of this double information system are that it facilitates the implementation of a simple security system for the TSA and airlines based upon the traveler and shipper's disclosure. It helps the airlines to expedite the boarding of passengers on the aircraft and eases the location of baggage and/or container upon arrival at the destination. In recent times the airlines are experiencing significant loss and misplacement of baggage much to the chagrin and displeasure of the traveling public. Easy identification of the contents of the container via this double information system is of immense benefit to the cargo shipping industry.

### BRIEF DESCRIPTION OF THE SEVERAL VIEWS OF THE DRAWINGS

FIG. 1 is a view of a typical traveling bag used by travelers for all modes of transportation including air, rail, ocean, highway (automobiles and buses). The view illustrates the scrolling device with its display panel and other components inside and outside of the bag. It is operated by a digital audio/video electronic mechanism or system which consists of a small “qwerty” computer keyboard (FIG. 4) embedded inside the bag or container. The display panel (FIG. 3) visually displays a message of up to 255 characters in a choice of up to seven different languages including English, German, French, Spanish, Swedish, Japanese, Chinese. The electronic power is provided by a 9 volt rechargeable lithium battery (FIG. 5), and an on/off touch button located on the outside of the bag (FIG. 6). The small computer keyboard (FIG. 4) permanently embedded inside the bag can be set manually or by electronically utilizing the computer memory chip connected via a standard USB connection on a regular computer. There is also a brightness control (FIG. 9) and a volume control (FIG. 11). A message is displayed on the LED panel (FIG. 3) by choosing numbers 0-9 and letters A to Z from the keyboard combined into any of the seven languages mentioned here. The video message can be reset manually or electronically using the computer chip.

The visual system is integrated with sound through a sound recording and playback mechanism (FIG. 8) inside the bag or container and a small speaker (FIG. 7) placed on the outside of the bag. The video-audio information is transmitted from the computer memory chip (FIG. 10). The language for the speaker is chosen by the operator of the device in addition to the visual depiction of the message on the scrolling display panel (FIG. 3).

### DESCRIPTION OF THE PREFERRED EMBODIMENT

The best mode contemplated for carrying out the invention is programming the visual and audio displays using the memory chip (FIG. 10) and its USB connection to set the computer so that it will quickly and with only a minimal effort display the desired video and audio information. It can be programmed manually by using the buttons on the computer keyboard (FIG. 4), but this is more time-consuming than the electronic programming. There are other digital LED scrolling devices in the form of, for example, a Name Tag Badge which displays a message on a name tag worn by the individual on his/her person. Subject invention is an improvement to the state of the art: (1) by employing new uses to the scrolling panel, i.e. the baggage used by travelers and also applying it to the cargo containers used by the shipping industry in commerce (see 35 USC 100 and 35 USC 101); (2) another improvement over existing art combines both the visual and audio function in the same device simultaneously or alternatively along with the manner in which the device is embedded in the traveling bags and cargo containers; and (3) using sound to identify the bag or container for blind persons.

The invention has a credible utility in that it is particularly useful to identify the owners of the baggage and cargo containers including, as to the latter, disclosure of the container's contents to TSA security cargo inspection, shippers and consignees of the cargo. For example, it is useful to identify and provide contact information to the viewer about the owner of the travel bags and/or cargo containers for travel and shipment via public carriers. The information displayed would promptly give the destination of the bag/container and other handling instructions such as in the case of produce or other perishables where time is critical and of the essence.

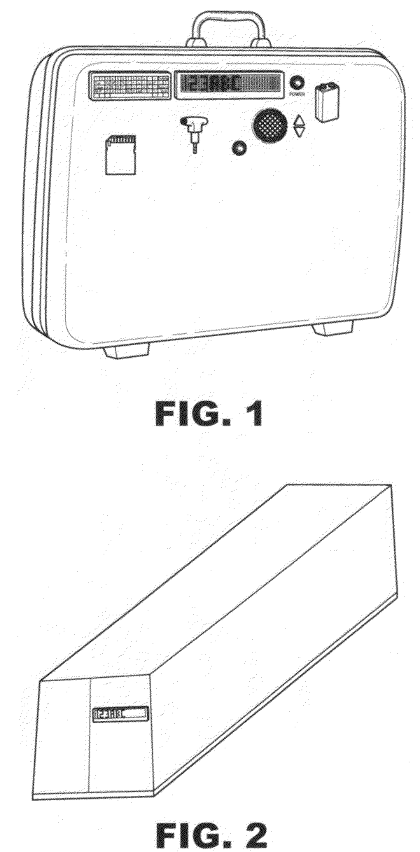

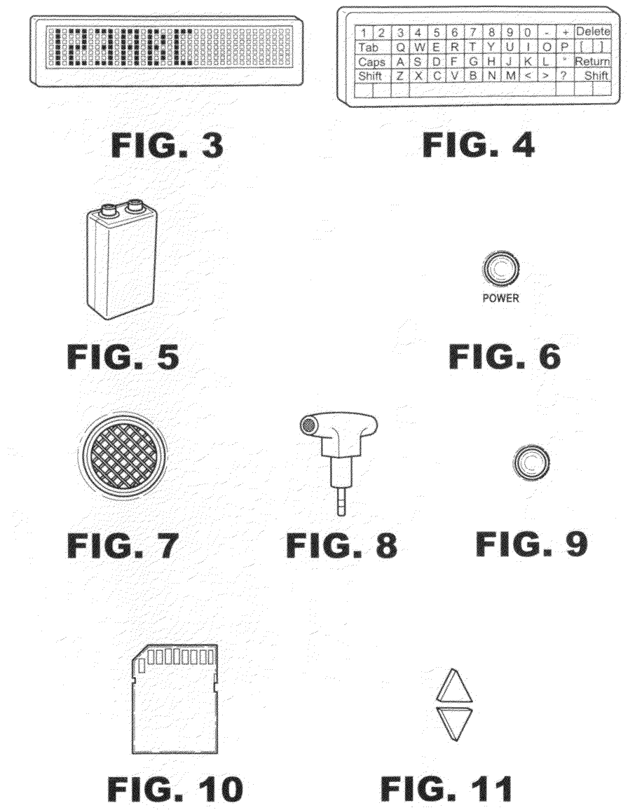

The utility of the invention also arises in the new uses to which the electronic scrolling device is put when used in commerce. It is the way the combination of the parts work in unison to produce both the visual effect and the sound. The parts and features for the visual display panel on the traveling bags which make the system work are as portrayed in FIG. 1, Drawing 1/2. It portrays an ordinary traveling bag in which the display panel and accessories to engage the scrolling message are embedded permanently. The digital scrolling video-audio display panel (FIG. 3) which contains the lighted numerals and alphabet characters form legible messages which spell out owner contact information and destination of the baggage. The key pad (FIG. 4) manually programs the message (FIG. 3). Power is supplied with a 9 volt rechargeable lithium battery (FIG. 5). An on/off touch button placed on the outside of the bag activates the power for the device (FIG. 6). The device also has a brightness control for the visual mode (FIG. 9) and a sound control for the sound mode (FIG. 11). When the speaker (FIG. 7) is turned on the voice message can be heard a distance of 20-30 feet. Although the aforementioned parts are in the current state of the art, no claim is made to each part; however, applicant does make claim to the new uses for the device and especially its dual or combined use of the system for displaying both a visual and audio message simultaneously or sequentially and also the manner in which it is embedded in the traveling bags and containers. Another use is for helping the blind traveling person to locate his/her baggage utilizing the electronic sound system.

What is claimed:

1. A new use for subject electronic scrolling device placed upon travel baggage or luggage and commercial shipping containers worldwide under Title 35 USCS Sections 100 and 101 for purposes of more positive identification of the owner including contact information and his/her itinerary or the contents and delivery instructions in the case of a commercial shipment.

2. A method of transmitting via a combination audio/video electronic device, both speech and data, through electronic means by placement of same on travel bags and/or commercial shipping containers used in worldwide commerce is designed for purposes of positive identification and contact information about the owner including his/her itinerary and delivery or destination instructions as well as information about the contents.
